(19) United States
(12) Patent Application Publication
(10) Pub. No.: US 2018/0294508 A1
(43) Pub. Date: Oct. 11, 2018

(54) LITHIUM ION BATTERY DIAPHRAGM AND METHOD FOR MANUFACTURING LITHIUMION BATTERY DIAPHRAGM

(71) Applicant: HON HAI PRECISION INDUSTRY CO., LTD., New Taipei (TW)

(72) Inventors: HSIN-NI CHIANG, New Taipei (TW); CHIA-LIN MA, New Taipei (TW); MING-SHU KUO, New Taipei (TW); PO-YEN CHEN, New Taipei (TW); WEN-CHIN CHEN, New Taipei (TW); CHAN-HSIANG HSU, New Taipei (TW); BI-SHENG JANG, New Taipei (TW); YU-HSUAN TANG, New Taipei (TW); CHIN-LUNG CHIU, New Taipei (TW); FENG-YUEN DAI, New Taipei (TW)

(21) Appl. No.: 15/631,201

(22) Filed: Jun. 23, 2017

(30) Foreign Application Priority Data
Apr. 11, 2017 (TW) 106112065

(51) Int. Cl. H01M 10/04; C08F 10/02; C08F 10/06; C08F 20/06; C08L 1/02

(52) U.S. Cl. CPC H01M 10/0459; C08F 10/02; C01F 11/462; C08F 20/06; C08L 1/02; C08F 10/06

(57) ABSTRACT

A lithium ion battery diaphragm includes a film and a ceramic layer, the ceramic layer is formed on at least one surface of the film to form a structure in the shape of a grid on the at least one surface of the film. A method for manufacturing the lithium ion battery diaphragm is also provided.

### CROSS-REFERENCE TO RELATED APPLICATIONS

This application claims priority to Taiwanese Patent Application No. 106112065 filed on Apr. 11, 2017, the contents of which are incorporated by reference herein.

### FIELD

The subject matter herein generally relates to lithium ion battery.

### BACKGROUND

The lithium ion battery diaphragm is widely used for higher capacities, higher outputs, no memory effect, and longer service life.

### BRIEF DESCRIPTION OF THE DRAWINGS

Implementations of the present technology will now be described, by way of example only, with reference to the attached figures.

FIG. 1 is a flow chart of an exemplary embodiment of a method for manufacturing a lithium ion battery diaphragm.

FIG. 2 is a top view of an exemplary embodiment of a lithium ion battery diaphragm.

FIG. 3 is a cross-section view of the exemplary embodiment of the lithium ion battery diaphragm shown in FIG. 1.

FIG. 4 is a top view of another exemplary embodiment of a lithium ion battery diaphragm.

FIG. 5 is a cross-section view of the exemplary embodiment of the lithium ion battery diaphragm shown in FIG. 4.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain sections have been exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

The present disclosure is described in relation to a method for manufacturing a lithium ion battery diaphragm, includes: providing a film; providing a mixture comprising adhesive and ceramic particles; coating the mixture on at least one surface of the film, to form a structure in a shape of a grid on the at least one surface of the film; and curing the mixture such that a ceramic layer is formed, to obtain a lithium ion battery diaphragm.

A lithium ion battery diaphragm of the disclosure includes a film and a ceramic layer; the ceramic layer being formed on at least one surface of the film, to form a structure in a shape of a grid on the at least one surface of the film.

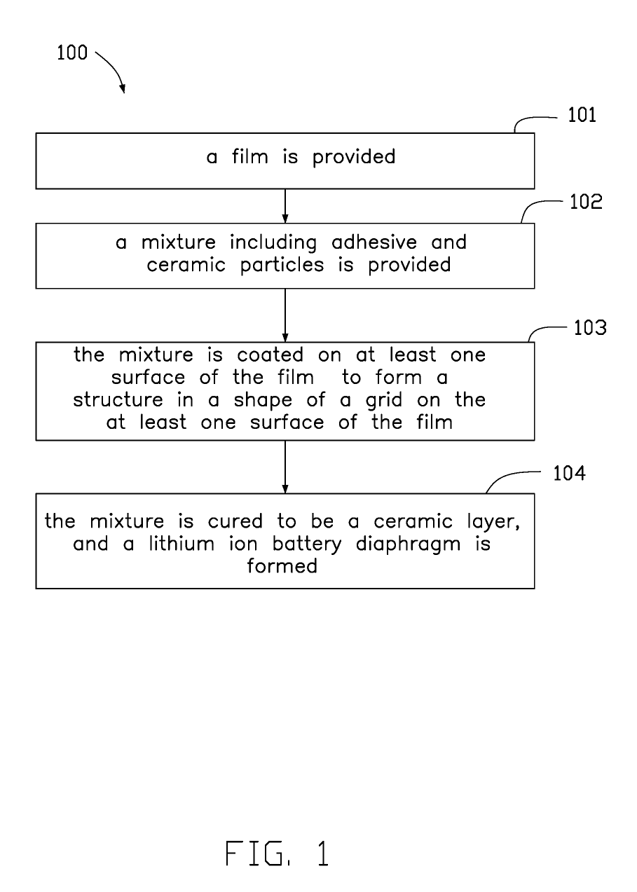

Referring to FIG. 1, a flowchart is presented in accordance with an example embodiment for manufacturing a lithium ion battery diaphragm. An example method 100 is provided by way of example, as there are a variety of ways to carry out the method. The method 100 described below can be carried out using the configurations illustrated in FIG. 1, for example, and various elements of these figures are referenced in explaining example method 100. Each block shown in FIG. 1 represents one or more processes, methods, or subroutines, carried out in the exemplary method 100. Additionally, the illustrated order of blocks is by example only and the order of the blocks can change. The exemplary method 100 can begin at block 101.

At block 101, a film is provided.

At block 102, a mixture including adhesive and ceramic particles is provided.

At block 103, the mixture is coated on at least one surface of the film to form a structure in a shape of a grid on the at least one surface of the film.

At block 104, the mixture is cured to be a ceramic layer, and a lithium ion battery diaphragm is formed.

The film can be a polyethylene film, a polypropylene film, a polypropylene/polyethylene/polypropylene composite film, a polyester film, a cellulose film, a polyimide film, a polyamide film, a spandex film, or an aramid film.

A thickness of the film can be less than 40 micrometers.

Preferably, the thickness of the film can be in a range from 15 micrometers to 25 micrometers when a battery with lithium ion battery diaphragm is used as a power source.

Preferably, the thickness of the film can be less than 7 micrometers when a battery with lithium ion battery diaphragm is used in digital electronics.

Preferably, a thickness of the ceramic layer is in a range from about 0.5 micrometers to 1.5 micrometers.

The adhesive can be made of polyvinylidene fluoride, polyacrylonitrile, polyoxyethylene, polyoxypropylene, polymethylmethacrylate, polyvinyl acetate, polyvinylidene fluoride-hexafluoropropylene copolymer, or any combination thereof.

Preferably, the adhesive can be polyvinylidene fluoride or polyvinylidene fluoride-hexafluoropropylene copolymer.

The adhesive can have a weight percent of a total weight of the mixture in a range from about 0.1% to about 5%.

The ceramic particles can be made of silicon dioxide, aluminum oxide, zirconium dioxide, titanium dioxide, magnesium dioxide, barium sulfate, calcium carbonate, magnesium hydroxide, or any combination thereof.

The ceramic particles can have a weight percent of a total weight of the mixture in a range from about 0.1% to about 5%.

The mixture can further include a solvent.

A thickness of the mixture coated on at least one surface of the film can be less than 8 micrometers.

Preferably, the thickness of the mixture coated on at least one surface of the film can be in a range from 0.5 micrometers to 2 micrometers.

The mixture can be coated on at least one surface of the film by a spread coating process, a printing process, or a spraying process.

In the present exemplary embodiment, the mixture is coated on the two opposite surfaces of the film.

The mixture can be coated on the surfaces of the film as a network of lines crossing each other, which produces a structure in a shape of a grid.

The mixture can be uniformly distributed as a network of lines crossing each other aslant or vertically crossing each other.

In the present exemplary embodiment, the mixture is uniformly distributed as a network of lines vertically crossing each other.

The mixture can be coated between a network of lines crossing each other aslant or vertically crossing each other, which produces a structure in a shape of a grid.

The mixture can be uniformly distributed, such as the blocks having a same size and same distance from each other.

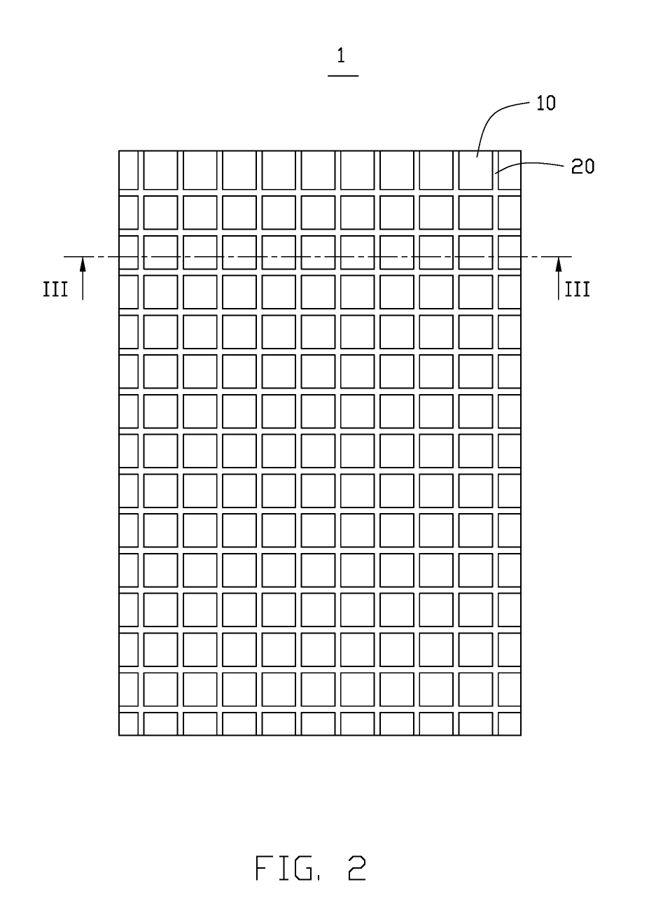

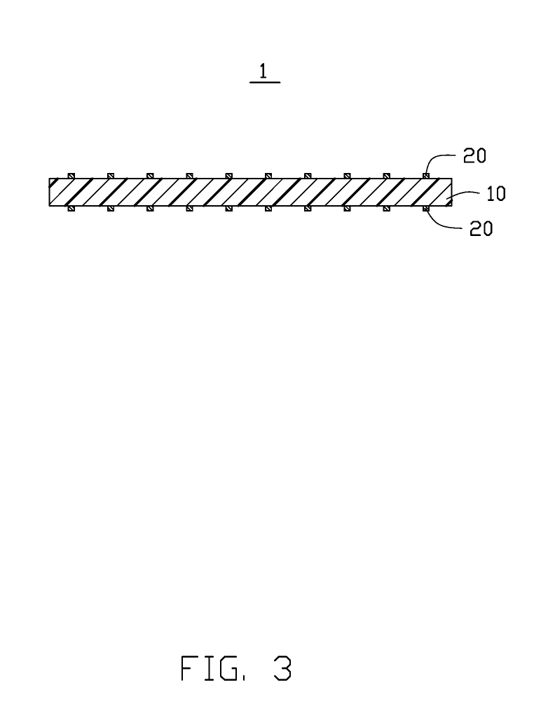

FIGS. 2 to 3 illustrate a lithium ion battery diaphragm 1 including a film 10 and two ceramic layers 20 formed on two opposite surfaces of the film 10. Each of the two ceramic layers 20 is in shape of a grid.

The film can be polyethylene film, polypropylene film, polypropylene/polyethylene/polypropylene composited film, polyester film, cellulose film, polyimide film, polyamide film, spandex film, or aramid film.

A thickness of the film can be less than 40 micrometers.

Preferably, the thickness of the film can be in a range from 15 micrometers to 25 micrometers when the lithium ion battery diaphragm is used in a power source.

Preferably, the thickness of the film can be less than 7 micrometers when the lithium ion battery diaphragm is used only for digital signalling.

The ceramic layer is cured from a mixture including adhesive and ceramic particles.

The adhesive can be polyvinylidene fluoride, polyacrylonitrile, polyoxyethylene, polyoxypropylene, polymethylmethacrylate, polyvinyl acetate, polyvinylidene fluoride-hexafluoropropylene copolymer, or any combination thereof.

Preferably, the adhesive can be polyvinylidene fluoride or polyvinylidene fluoride-hexafluoropropylene copolymer.

The adhesive can have a weight percent of a total weight of the mixture in a range from about 0.1% to about 5%.

The ceramic particles can be made of silicon dioxide, aluminum oxide, zirconium dioxide, titanium dioxide, magnesium dioxide, barium sulfate, calcium carbonate, magnesium hydroxide, or any combination thereof.

The ceramic particles can have a weight percent of a total weight of the mixture in a range from about 0.1% to about 5%.

The mixture can further include a solvent.

A thickness of the mixture coated on at least one surface of the film can be less than 8 micrometers.

Preferably, the thickness of the mixture coated on at least one surface of the film can be in a range from 0.5 micrometers to 2 micrometers.

In other exemplary embodiments, the mixture can be coated on one surface of the film only.

Each of the two ceramic layers 20 can be coated on the surfaces of the film 10 as a network of lines uniformly crossing each other either vertically or aslant, which produces a structure in a shape of a grid.

In the present exemplary embodiment, each of the two ceramic layers 20 is uniformly distributed as a network of lines vertically crossing each other.

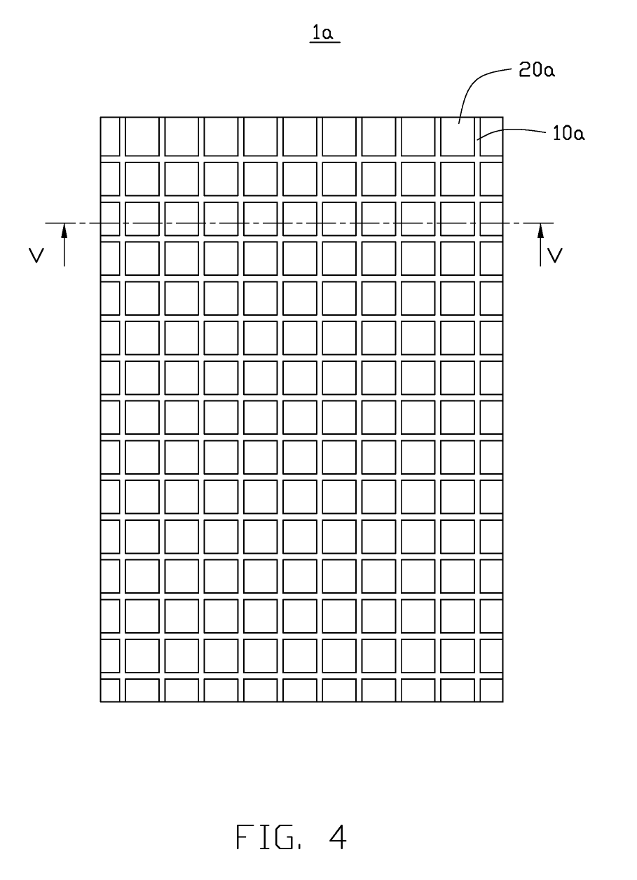

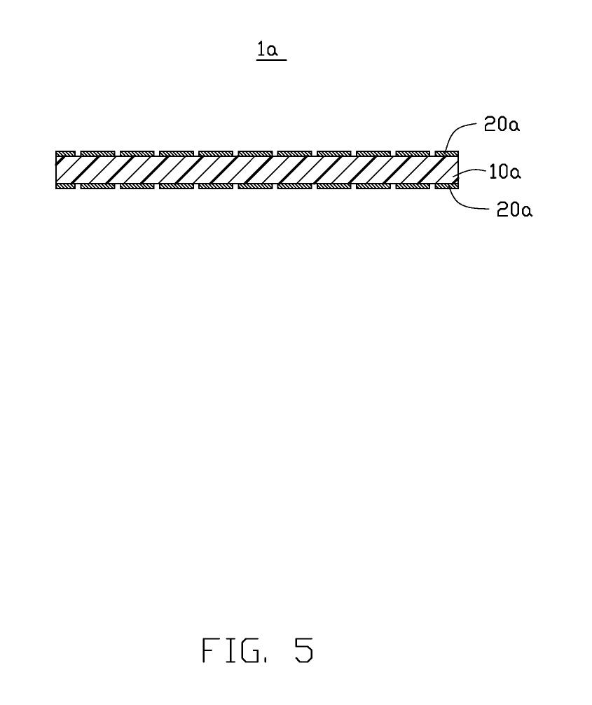

FIGS. 4 to 5 illustrate a lithium ion battery diaphragm 1a, which is similar to the lithium ion battery diaphragm 1 in FIGS. 2 to 3. The differences are that the ceramic layer 20a is distributed between a network of lines crossing each other aslant or vertically, which produces a structure in a shape of a grid.

### EXAMPLE 1

A method for manufacturing lithium ion battery diaphragm includes the following steps.

A film made of polyethylene is provided. A thickness of the film is about 5 micrometers.

A mixture including adhesive made of polyvinylidene fluoride, and ceramic particles made of silicon dioxide, calcium carbonate and magnesium hydroxide, is provided. The adhesive has a weight percent of a total weight of the mixture in about 1%. The ceramic particles can have a weight percent of a total weight of the mixture in about 1%.

The mixture is coated on two opposite surfaces of the film and is distributed as a network of lines crossing each other. A thickness of the mixture is slightly more than 1 micrometer.

The mixture is cured to become a ceramic layer, and a lithium ion battery diaphragm is formed. A thickness of the ceramic layer is about 1 micrometer.

### EXAMPLE 2

A lithium ion battery diaphragm manufacturing by the method in example 1 includes a film and two ceramic layers formed on two opposite surfaces of the film. Each of the two ceramic layers is distributed as a network of lines crossing each other. A thickness of the ceramic layer is about 1 micrometer. A thickness of the film is about 5 micrometers.

The exemplary embodiments shown and described above are only examples. Many details are often found in the art such as the other features of a lithium ion battery diaphragm and a method for manufacturing the lithium ion battery diaphragm. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the sections within the principles of the present disclosure, up to and including the full extent established by the broad general meaning of the terms used in the claims. It will therefore be appreciated that the exemplary embodiments described above may be modified within the scope of the claims.

What is claimed is:

1. A method for manufacturing a lithium ion battery diaphragm, comprising:
providing a film;
providing a mixture comprising adhesive and ceramic particles;
coating the mixture on at least one surface of the film, to form a structure in a shape of a grid on the at least one surface of the film; and
curing the mixture such that a ceramic layer is formed to obtain a lithium ion battery diaphragm.

2. The method of claim 1, wherein the film is a polyethylene film, a polypropylene film, a polypropylene-polyethylene-polypropylene composite film, a polyester film, a cellulose film, a polyimide film, a polyamide film, a spandex film or an aramid film.

3. The method of claim 1, wherein a thickness of the film is less than 7 micrometers, and a thickness of the mixture coated on at least one surface of the film is in a range from 0.5 micrometers to 2 micrometers.

4. The method of claim 1, wherein the adhesive is made of polyvinylidene fluoride, polyacrylonitrile, polyoxyethylene, polyoxypropylene, polymethylmethacrylate, polyvinyl acetate, polyvinylidene fluoride-hexafluoropropylene copolymer, or any combination thereof.

5. The method of claim 1, wherein the adhesive has a weight percent of a total weight of the mixture in a range from about 0.1% to about 5%.

6. The method of claim 1, wherein the ceramic particles is made of silicon dioxide, aluminum oxide, zirconium dioxide, titanium dioxide, magnesium dioxide, barium sulfate, calcium carbonate, magnesium hydroxide, or any combination thereof.

7. The method of claim 1, wherein the ceramic particles have a weight percent of a total weight of the mixture in a range from about 0.1% to about 5%.

8. The method of claim 1, wherein the mixture is coated on at least one surface of the film as a network of lines crossing each other.

9. The method of claim 1, wherein the mixture is coated between a network of lines crossing each other.

10. A lithium ion battery diaphragm, comprising:
a film, and
a ceramic layer, the ceramic layer being formed on at least one surface of the film, to form a structure in a shape of a grid on the at least one surface of the film.

11. The lithium ion battery diaphragm of claim 10, wherein the ceramic layer is cured by a mixture comprising adhesive and ceramic particles.

12. The lithium ion battery diaphragm of claim 11, wherein the adhesive is made of polyvinylidene fluoride, polyacrylonitrile, polyoxyethylene, polyoxypropylene, polymethylmethacrylate, polyvinyl acetate, polyvinylidene fluoride-hexafluoropropylene copolymer, or any combination thereof.

13. The lithium ion battery diaphragm of claim 11, wherein the ceramic particles is made of silicon dioxide, aluminum oxide, zirconium dioxide, titanium dioxide, magnesium dioxide, barium sulfate, calcium carbonate, magnesium hydroxide, or any combination thereof.

14. The lithium ion battery diaphragm of claim 11, wherein the adhesive has a weight percent of a total weight of the mixture in a range from about 0.1% to about 5%; the ceramic particles have a weight percent of a total weight of the mixture in a range from about 0.1% to about 5%.

15. The lithium ion battery diaphragm of claim 10, wherein the film is a polyethylene film, a polypropylene film, a polypropylene/polyethylene/polypropylene composite film, a polyester film, a cellulose film, a polyimide film, a polyamide film, a spandex film or an aramid film.

16. The lithium ion battery diaphragm of claim 10, wherein a thickness of the film is less than 7 micrometers, and a thickness of the ceramic layer coated on at least one surface of the film is in a range from 0.5 micrometers to 1.5 micrometers.

17. The lithium ion battery diaphragm of claim 10, wherein the ceramic layer is coated on at least one surface of the film as a network of lines crossing each other.

18. The lithium ion battery diaphragm of claim 10, wherein the ceramic layer is coated between a network of lines crossing each other.
